(19) United States
(12) Patent Application Publication
(10) Pub. No.: US 2025/0071153 A1
(43) Pub. Date: Feb. 27, 2025

(54) System and Method For Enabling Real-Time Online Human or Human-Equivalent Connection of Assistance

(71) Applicants: Adam Charles Rubin, Los Angeles, CA (US); Gary Jack Kramer, Los Angeles, CA (US)

(72) Inventors: Adam Charles Rubin, Los Angeles, CA (US); Gary Jack Kramer, Los Angeles, CA (US)

(21) Appl. No.: 18/236,935

(22) Filed: Aug. 22, 2023

(51) Int. Cl. H04L 65/1063; H04L 65/40; H04L 67/104

(52) U.S. Cl. CPC H04L 65/1063; H04L 65/40; H04L 67/104

(57) ABSTRACT

The present invention is related to a network-based system and method for real-time online human or human-equivalent assistance that allows a user to connect with an online advisor/helper in real-time, wherein the online advisor/helper assists the user in communicating, providing expertise and/or doing things, both on or offline, including using apps of a personal digital device with or without the click of a button for searching, getting information, transacting, communicating, emoting, connecting with others, getting expertise, learning, multi-tasking, navigating the digital world, and much more. The network-based system comprising a mobile/web-based application for the personal digital device having a program and circuitry, is connected to by the user via a digital link, QR Code or another digital linking method, or installed by the user and online advisor/helper in their respective personal digital devices for the real-time online interaction, creating a peer-to-peer connection therebetween via a server and the Internet. This provides new hope for many to be able to access video, text and audio-based communication and expertise, and do a wide range of things, both on and offline, more easily.

### BACKGROUND OF THE INVENTION

### Field of the Art

The system and method of the present invention relates to the field of online video, text, file-sharing and audio assistance technology and related business platforms. More particularly the system and method of the present invention relates to the field of enabling real-time online human or human-equivalent connection or assistance to a user of a personal digital device, wherein the initial user is someone who needs access to help, support, information, discussion, and expertise he/she desires or cannot get on his/her own.

### Discussion of the State of the Art

This advancement in digital technology and business model results in more complex functional capability for a huge group of people via smartphones, computers, tablets, personal digital assistants, etc.

A few prior arts have been disclosed which describe providing an online help platform. One of the prior arts, U.S. Pat. No. 10,725,801B2, discloses a method of interaction between a user and live help where “a live human agent or an automated helper” points to a portion of a user's screen. The agent may direct the user to various components, located on or off of the user's graphical user interface, by pointing to a feature either on or outside of the user's GUI. The agent or the agent's interface is capable of processing or identifying the geographical locations of the physical features outside of the user's display area, without needing to view the physical features. Therefore, the system may be referred to as “geographical live support.”

The above-mentioned prior art discusses providing interaction between a single user and live helper where the two parties communicate with each other by visually referencing the physical specific locations of the two parties that are communicating through a screen. The prior art mainly describes a helper being able to assist a user with respect to a singular device or system, and does not disclose anything about providing assistance via different digital applications, using a range of features & functions of the personal digital devices themselves, and also does not address the way that many people can use a system and capability to engage in a range of simultaneous and non-simultaneous actions between them. Hence, there is a need to invent a system and method which particularly focuses on these wide ranging digital human interactions to occur on a singular or large scale and for many simultaneous and non-simultaneous actions.

Another prior art, CN101237327A, discloses an online assistance platform system and realization method wherein there is at least one seeking-for-help party device and at least one help party device. The online help information includes images and operational information, word messages, pictorial information, voice messaging, and video information and files etc. The prior art does not disclose anything regarding a live online helper and/or live human face-to-face assistance. It is only restricted to limited screen pointing and annotation. Also, the prior art does not disclose anything about providing assistance in using different digital applications or incorporating different features and functions of the personal digital devices themselves. And the prior art does not mention a business system related to it.

Furthermore, the above-mentioned prior arts do not disclose multiple problems that can be addressed with the possibility of a system of online live human or human-equivalent assistance. This includes automobile drivers and customer service. Driving & texting or driving & working on one's phone is incredibly dangerous. There is a need for a way for people to remain productive while driving. The system of the present invention helps with the aforesaid need. In addition, a chatbot for customer service is not super-efficient as it typically requires far more understanding than current artificial intelligence (AI) can provide. Despite the desire for current AI to completely help people with their needs, it often seems to come up short versus a human being in terms of authentically providing appropriate and in-depth solutions given the current level of technology.

Despite the complexity of the above-mentioned prior conventional arts, they do not describe providing instant and real-time online human or human-equivalent assistance. Additionally, the conventional arts do not describe accessing live human or human-equivalent support without the click of a button. Furthermore, the conventional arts do not provide adequate solutions to drivers for multi-tasking using digital devices while driving safely. The conventional arts also do not overcome limitations associated with chatbots. The unique characteristics and features of the system and method of the present invention are therefore unrepresented within the prior arts.

The aforesaid conventional arts encounter various shortcomings. Hence, there is a significant need and void in the market for inventing a system and a method which provides real-time online human or human-equivalent connectivity and assistance to the users of personal digital devices.

More specifically, there is no such network-based system and method known in the prior art that allows a user to establish online face-to-face human or human-equivalent support in real-time for online communication or customer service type platforms. Additionally, such systems can ultimately be used 24 hours a day/7 days a week (24/7) based on this system, to take care of any connections or needs that can be created by the online helper per the online user's request.

Furthermore, the applicant is unaware of any such method or system whereby the online helper providing real-time human assistance can then refer the user needing assistance to another online helper who has expertise in the field the user is requesting assistance.

### SUMMARY OF THE INVENTION

The main object of the present invention is to overcome the problem associated with traditional online video, text, audio, and file transfer connection and assistance systems by providing a network-based system and method for real-time online human or human-equivalent connection or assistance that allows a user to connect with someone, including an online helper, in real-time, wherein the online helper assists the user.

Accordingly, the inventor has conceived and reduced to practice, in a preferred embodiment of the invention, the network-based system and method for real-time online human or human-equivalent communication or assistance comprising a two-sided platform in the form of a mobile/web-based application for people who need communication, advice or assistance and the people or human-equivalent digital creations who provide communication, advice or assistance, which transforms the way that a huge segment of the global population, including people over the age of 50, to interact via digital technology, primarily on devices such as a smartphone, tablet or computer. The present invention introduces a novel system and method for personal digital devices having a program and circuitry for the real-time online interaction between the user and the online communicator or advisor/helper, wherein either the online communicator or advisor/helper assists the user with solving a variety of problems, and the need for expertise in a particular area to solve more technical and specific problems etc. In addition, the present invention helps people dealing with physical and emotional issues, such as loneliness or depression, and solves real world problems, such as issues around the house including, but not limited to, plumbing or using movie programs like Netflix. The system of the present invention comprises the mobile/web-based application accessible via Internet, to run via the personal digital device including, but not limited to smartphones, computers, wearable devices, tablets, i-Pads or other mobile computing devices.

According to the present invention, user interaction is instigated either by installing a mobile/web-based application (installed by the user and an online communicator or helper on their respective personal digital devices) or by clicking on a digital link, QR Code, or other digital connection. Users can open the mobile/web-based application by just clicking on the application icon, a link, QR code or future digital linking method, and then the user is able to gain instant live access to the available communicator or online advisor/helper that offers assistance with expertise, advice and a number of things online. The mobile/web-based application of the present invention can also be integrated with a “virtual assistant” (e.g. Apple's Siri) of the personal digital device, hence if the user attempts to ask/say a word or phrase such as “online assistance”, “need live assistance”, “online help”, “need live help,” “need live person”, or something relevant, then the virtual assistant automatically transfers the user to the mobile/web-based application (App) of the present invention. In this way, the user can access the mobile/web-based application without the click of a button. The user is connected to a server via an Internet or Intranet type platform, wherein the system software is hosted. The server connects the user to the available communicator or online advisor/helper and enables a peer-to-peer connection between them via the Internet or Intranet type communication platform.

The main purpose of the present invention is to provide a new way for digital users, including non and limited technology users, to be able to directly connect and receive advice and assistance on their personal digital devices. In addition, the present invention also assists these users with a wide variety of both physical and emotional problems, including loneliness and depression, while providing a respite for friends and family members to resolve a massive “pain point”-having to help these people. This “pain point” takes up a huge amount of time and causes tremendous frustration for helpers and those receiving help. Therefore, this real-time online human or human-equivalent assistance system and method of the present invention provides multi-fold benefits for a wide range of people which are described in the following pages of specification.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram of a functional architecture for a network-based system for real-time online human or human-equivalent connection and assistance, according to an embodiment of the present invention.

FIG. 2 illustrates an exemplary flow diagram of a connection or sign-up process for the system or an app that is part of the system by a user, wherein the user registers with a mobile/web-based application, according to an embodiment of the present invention.

FIG. 3 illustrates an exemplary flow diagram of a sign-up process for a potential Consumer platform based on the system whereby an online helper, wherein the online helper registers with a mobile/web-based application, according to an embodiment of the present invention.

The figures are described in greater detail in the next section of the patent specification.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

It is to be also understood that the phraseology and terminology employed herein is for the purpose of description and not of limitation.

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

### Definitions

As used herein the following terms have the meaning given below:

“User”—means any person who utilizes the system and/or is registered with a system of the present invention, and needs assistance with a wide range of topics and actions.

“Communicator”—means any person that is able to communicate via the system using video, audio, text, or file transfer.

“Human assistant”—means any human who is registered with a system of the present invention, and provides online human assistance in real-time to the user.

“Human-equivalent assistant”—means cognitive artificial intelligence (AI) resembling human intelligence which is incorporated in a system of the present invention to provide online human-equivalent assistance in real-time to the user.

“Online helper”—means any human assistant and/or human-equivalent assistant who is associated with a system of the present invention to provide online help or online assistance in real-time to the user.

“Personal digital device”—means any computing device that combines communication gateway and computing functions into one unit i.e. smartphones, computers, wearable devices, tablets, i-Pads or other mobile computing devices.

“User device”—means any personal digital device owned by a user on which a mobile/web-based application is installed.

“Online helper device”—means any personal digital device owned/used by a human assistant or controlled by a human-equivalent assistant on which a mobile/web-based application is installed.

“Central server” or “server”—means, in a preferred embodiment, an entity comprising a computer hardware or software program that provides functionality for other programs or the devices, wherein the program adapted to implement a system and a method for managing interaction between a user device and an online helper device.

### DETAILED DESCRIPTION OF EXEMPLARY EMBODIMENTS

The following description is presented to enable one skilled in the art to make and use the invention, and is provided in the context of particular applications and their requirements. Various modifications to the disclosed embodiment will be apparent to those skilled in the art, and the general principals set forth below may be applied to other embodiments and applications. Thus, the present invention is not intended to be limited to the embodiments shown and the inventor regards this invention as any patentable subject matter described herein.

The present invention discloses a network-based system and method for real-time online human or human-equivalent assistance that allows a user to connect with another person or online helper in real-time, wherein the person can discuss information or an online helper can assist the user by providing assistance or expertise. The network-based system of the present invention comprises a two-sided platform in form of a mobile/web-based application accessible via the Internet, to run by a plurality of user devices and a plurality of online helper devices.

Reference will now be made in detail to a presently preferred embodiment of the invention, an example of which is illustrated in the accompanying drawings.

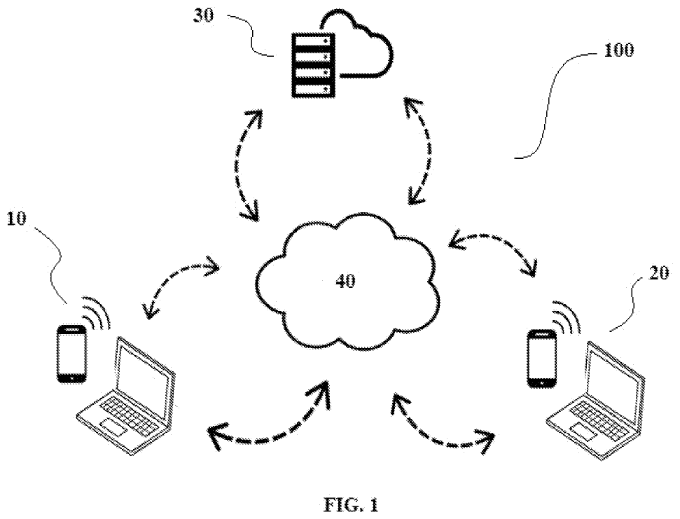

According to an exemplary embodiment of the present invention, a functional architecture of the network-based system 100 for the real-time online human or human-equivalent assistance is shown in FIG. 1. Referring to FIG. 1, the network-based system 100 is based on free or charge or alternative payment systems (e.g. per minute and monthly subscription-based models) depending on the needs of the user, wherein the network-based system 100 comprising at least one user device 10 from the plurality of user devices including at least a processor and a memory, at least one online helper device 20 from the plurality of online helper devices including at least a processor and a memory, a server 30 (or a plurality of servers) wherein a system software is hosted, and the Internet 40 to establish a communication between the user device 10, the online helper device 20, and the server 30.

Further referring to FIG. 1, the user clicks a link, QR Code or future digital linking method or installs a mobile/web-based application in the user device 10 and signs in as the user via a user facing gateway, wherein an initial connection to the server 30 is made via the Internet 40. Similarly, an online helper installs the mobile/web-based application in the online helper device 20 and signs in as the online helper via an online helper facing gateway. Upon assistance request by the user, the server 30 connects the user to the online helper via the Internet 40, and enables a peer-to-peer connection therebetween. The system software hosted by the server 30 is developed using system programming methodologies and systems programming languages, and designed specifically to execute a program for the mobile/web-based application of the present invention. The network-based system 100 stores and manages all the information inputted by the user, communicator, or online helper. Furthermore, a plurality of additional users might be queued up and follow the same pattern of the user facing gateway. Also, a plurality of additional online helpers might be queued up and follow the same pattern of the online helper facing gateway.

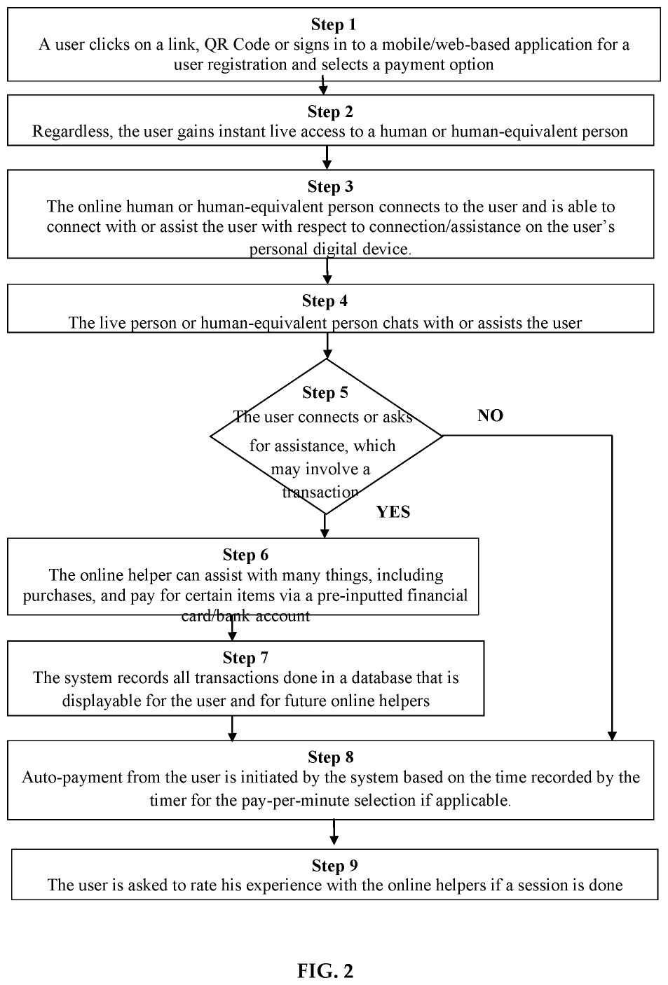

According to various embodiments of the present invention, a several process steps of the network-based system 100 are shown in FIGS. 2 & 3. If the mobile/web-based application is installed on the user device, 10 includes the user facing gateway that the user will be using to interact with the online helper to have assistance from him. The user-facing gateway comprises a plurality of sequential steps to be accomplished by the user if he uses the system as shown in FIG. 2. Referring to FIG. 2, at an input step 1 in starting with the process, the user either clicks a link, QR Code or future digital linking method or downloads an app and registers himself as the user by signing in to the mobile/web-based application, and selects a payment option (e.g. monthly subscription option or a pay-per-minute payment). Signing in, is often a one-time task, which can either be done by the user, or for the user by the online helper who is answering, who logs in for the user and can also register for the user the first time they join the platform. While registration, the user might need to provide personal information and financial payment details for the purpose of various payments (i.e. payment for shopping, payment to the online helper for his service, etc.) The financial payment details are highly secured by the network-based system 100.

At step 2, once the user is connected to the platform, either via digital link, QR Code or future digital linking method or in the mobile/web-based application after registration, he is able to gain instant live access to the online helper that offers advice or assistance with a number of things online. Further at step 3, in a current form of the platform, an inbuilt digital timer starts, and the online helper approaches the user and asks about any assistance the user may need. An example use may be that the online helper is able to assist the user with different transactions including: travel booking, prescription filing, emergencies, searching browsers, entertainment, rideshare, direction and navigation, message and communication, media share and transfer, screen personalization, apps and windows, emoting and many more things the user may desire. Additional potential uses might explore an online helper assisting with any emotional or physical requirements or needed solutions that the user may require. This might even be unrelated to any app in particular, such as, but not limited to, providing technical or other assistance or coordinating with a 3rd party to assist with such assistance. At step 4, the online helper provides assistance to the user, which might include apps/tasks he needs assistance with.

Furthermore, at step 5, if any advice or apps/tasks for which the user has asked for assistance which involve transactions, then the process would move forward to further steps 6 & 7. And, if any apps/tasks for which the user has asked for advice or assistance with, which do not involve transactions, then the process would skip steps 6 & 7 and move forward to step 8.

In case the apps/tasks for which the user has asked for assistance which involve transactions, then at step 6, the online helper could assist with making purchases and paying for the purchase using the financial payment details submitted by the user during registration. For instance, the user inputs some information into a database on the online helper's end, i.e. item SKU numbers, flight dates, times, specific airlines, and prices. From there, the required needs of the user are instantly made available to the transaction coordinator at a central location. The transaction coordinator orders the requested items using the mobile/web-based application's own corporate accounts and then bills the user and/or certain family members once transactions have been placed. The users' financial information will most probably not be unavailable to the individual online helper around the world. Specified transaction coordinators may be the sole people with access to any financial information of the user. Further at step 7, the network-based system 100 records all the transactions done in a database that is displayable for the user and for the future online helpers.

At step 8, the network-based system 100 initiates an auto-payment for the advice/assistance payment (potentially tips, pay-per-minute selection or subscription) from the user based payment choices they have previously made. If they have chosen the pay-per-minute, they will pay based on the time recorded by the inbuilt digital timer of the mobile/web-based application. The inbuilt digital timer is located on a graphical user interface of the user device 10. Further at final step 9, the network-based system 100 asks the user to rate his experience of using service of the online helper once a session is completed. The rating system will create an average score based on all the different users the online helper has helped.

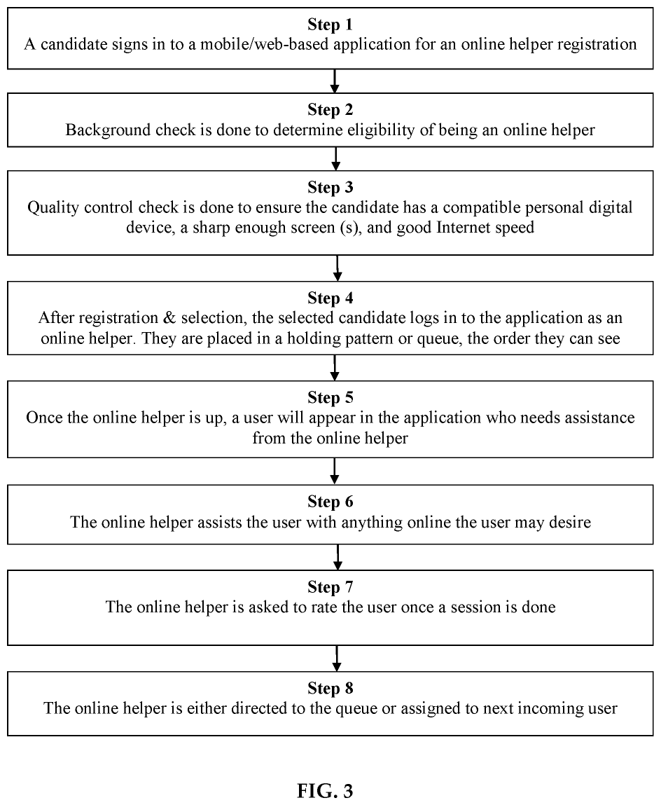

According to abovementioned embodiment of the present invention, the mobile/web-based application installed on the online helper device 20 includes the online helper facing gateway that the online helper will be using to interact with the user to provide assistance to the user. The online helper facing gateway comprises a plurality of sequential steps to be accomplished by the online helper as shown in FIG. 3. Referring to FIG. 3, at an input step 1, a candidate registers himself as the online advisor/helper or a human assistant by signing in to the mobile/web-based application. While registering, the candidate might need to submit his personal identification information. Further, the candidate might need to submit the information about the type of mobile or computer system he has. At step 2, a background check is done and potentially an online interview is conducted by a third party entity, to determine the eligibility and capability of the candidate. Further at step 3, a quality check is done for candidate's personal digital device with respect to operating system, monitor, webcam, etc., hence to ensure the candidate has compatible personal digital device to efficiently accomplish the job of the online helper. Also, potentially, internet speed is assured for uninterrupted service from the candidate.

Proceeding towards step 4, once the advisor/helper is approved and his registration is confirmed, he needs to sign in and/or log in to the mobile/web-based application. After signing in, the online advisor/helper will go into a holding pattern or queue. At step 5, when the online advisor/helper is up for providing assistance, the user would appear on his graphical user interface and he will be able to help the user. When the user appears, the online helper will be able to see the information of the user including, but not limited to, potential information such as the user's prior shopping and transaction history for a certain use. Further at step 6, the online advisor/helper assists the user with a range of possibilities including . . . advice . . . and transactions including anything online the user has asked for, such as travel booking, prescription filling, emergencies, searching browsers, entertainment, rideshare, directions and navigation, messages and communication, media share and transfer, screen personalization, apps and windows, emoting, any physical or emotional requests, referrals to other helpers for help with particular required expertise, and many more things the user may desire. The online advisor/helper will be able to share his graphical user interface with the user in a way that is customized for optimum viewing, primarily on the smartphone.

At step 7, the network-based system 100 asks the online advisor/helper to rate the user once a session is completed. The network-based system 100 then tracks and determines the average score of the user from all the ratings. At step 8, after completing one session, the online helper may directed to the online helper queue or may be assigned to the next incoming user.

In the online helper-facing gateway, after logging in, the online advisors/helpers can see and review their average ratings on the graphical user interface of their devices. The online helpers can also see their online status, how much time they have been online and for how long. The online helpers can also see their earning and tips. Further, when the online advisors/helpers join the queue, their turn to provide assistance is determined based on an algorithm—this could be a number of things including their rating and the number of users in waiting. The network-based system will potentially let them know if there's a wait and how long. Moreover, the online advisors/helpers might be credited a bonus on defined time for getting others to join the network-based system. In this way, the online helper gateway of the network-based system enables people to earn money from home or on the go. The online helper gateway provides an opportunity to make provide assistance and earn income from anywhere in the world.

Also an online advisor/helper can direct the user to another online advisor/helper for additional assistance (including technical), or bring in that online advisor/helper into the communication.

According to an embodiment of the present invention, accessing the mobile/web-based application can be very simple by integrating it with a “virtual assistant” (e.g. Apple's Siri) of the personal digital device, hence if the user attempts to ask/say a word or phrase such as “online assistance”, “need live assistance”, “online help”, “need live help,” “need live person”, or something relevant, then the virtual assistant automatically transfers the user to the mobile/web-based application of the present invention. In this way, the user can have the access to the mobile/web-based application without the click of button. The mobile/web-based application can also be accessed by just clicking the app icon, clicking one button within the app if it is open, or merely by going to the website URL. In addition, the platform can also be accessed from an online URL link or a physical or digital QR Code or future digital linking method.

The network-based system and method of the present invention for real-time online human or human-equivalent assistance is highly advantageous over current online assistance systems. The network-based system is unique in a number of ways including providing a solution for those that don't have the ability to use digital-based technology to do a range of things or don't have the time to be able to do this for oneself. The system of the present invention focuses on a wide range of people, but also the elderly and drivers who would like to stay productive while driving. The network-based system can be used as stand-alone, but can also be integrated with other online applications and marketplaces. This could be as an API, enabling different software platforms to hook-in and include the system's functionality within their different software offerings. Additional advantages include when someone needs customer service help and they arrive at a page of the mobile/web-based application of present invention and the online advisor/helper appears on the page. The network-based system of present invention represents a way for people to re-connect with the human or human-equivalent side of things. With the system of present invention, people no longer have to worry about how they or their loved ones will be able to receive assistance and then potentially transact, search, find information and directions, use ride share, and communicate without any technical knowledge. In addition, the system offers a wide range of people from all walks of life the opportunity to earn income as an online advisor/helper from home or anywhere they choose. The present invention is here to simplify and enhance the lives of many.

While certain embodiments of the inventions have been described, these embodiments have been presented by the way of example only, and are not intended to limit the scope of the disclosure. Indeed, the novel methods and system described herein may be embodied in a variety of other forms; furthermore, various omissions, substitutions and changes in the form of the methods and systems herein may be made without departing from the spirit of the disclosure. The accompanying claims and their equivalents are intended to cover such forms or modifications as would fall within the scope and spirit of the inventions.

The skilled person will be aware of a range of possible modifications of the various embodiments described above and many other possible applications of the present invention may be reduced to practice. Therefore, the present invention is not limited by the specific embodiments described above. Accordingly, the present invention is defined by the claims and their equivalents.

1. A network-based system for real-time online human or human-equivalent assistance, comprising:
a plurality of user devices having a mobile/web-based application, wherein the mobile/web-based application comprising a user-facing gateway for a plurality of users, wherein a first user, with the first user being associated with at least one user device, clicks a digital link or QR Code, or signs in to the mobile/web-based application via the user-facing gateway;
a plurality of online helper devices having the mobile/web-based application, wherein the mobile/web-based application comprising an online helper-facing gateway for a plurality of online helpers, wherein a first online advisor/helper with the first online advisor/helper being associated with at least one online advisor/helper device signs in to the mobile/web-based application via the online helper-facing gateway;
a server to connect the first user to the first online advisor/helper via the Internet to enable a peer-to-peer connection there between, upon assistance request by the first user, wherein the server hosts the system software which is developed using system programming methodologies and systems programming languages and is designed specifically to execute a program for the mobile/web-based application.

2. The network-based system for real-time online human or human-equivalent assistance as claimed in claim 1, wherein the system stores and manages all the information inputted by the first user and the first online advisor/helper.

3. The network-based system for real-time online human or human-equivalent assistance as claimed in claim 1, wherein a plurality of additional users are queued up and follow the same pattern of the user facing gateway.

4. The network-based system for real-time online human or human-equivalent assistance as claimed in claim 1, wherein a plurality of additional online advisors/helpers are queued up and follow the same pattern of the online advisor/helper-facing gateway.

5. The network-based system for real-time online human or human-equivalent assistance as claimed in claim 1, wherein the mobile/web-based application can be integrated with a virtual assistant of a personal digital device.

6. A network-based method for real-time online human or human-equivalent assistance, wherein a plurality of users sign up to a mobile/web-based application for a user registration via a plurality of user devices, wherein each user device, comprising at least a processor and a memory, and wherein the network-based method for real-time online human assistance comprising the steps of:
deploying a server, wherein the server hosts system software developed using system programming methodologies and systems programming languages, and designed specifically to execute a program for the mobile/web-based application;
signing in to the mobile/web-based application by a first user for a user registration, and selecting a payment option, such as a monthly subscription, pay-per-minute/amount of time, or other options;
gaining instant live access to a first online advisor/helper once the user registration is done by the first user;
approaching the first user by the first online advisor/helper to assist the first user with advice or a number of things online;
providing assistance to the first user by the first online helper once the first user confirms the advice/assistance or apps/tasks he needs assistance with;
making purchase and payment by the first online helper, if the apps/tasks for which the first user has asked assistance involve transactions;
recording all the transactions done in a database that is displayable for the first user and for a plurality of future online advisors/helpers;
initiating an auto-payment if the first user has selected a form of payment including a pay-per-minute/amount of time option, wherein the time is recorded by an inbuilt digital timer or a form of tipping;
rating the first online advisor/helper by the first user, based on his experience of using service of the first online advisor/helper, once a session is completed.

7. The network-based method for real-time online human or human-equivalent assistance as claimed in claim 6, wherein the connecting can be done via online link, QR Code or future digital linking method, or signing in can be done by the first user, or for the first user by the first online advisor/helper.

8. The network-based method for real-time online human or human-equivalent assistance as claimed in claim 6, wherein the inbuilt digital timer starts when the first online advisor/helper approaches the first user.

9. The network-based method for real-time online human or human-equivalent assistance as claimed in claim 6, wherein the first online helper assists the first user with providing communication, advice, expertise, or assistance and then potentially using a plurality of apps including, but not limited to transactions, travel booking, prescription filling, emergencies, searching browsers, entertainment, rideshare, direction and navigation, messages and communication, media sharing and transfer, screen personalization, apps and windows, any physical and emotional needs, and needs for expertise and assistance in any areas, both technical and non-technical.
